(19) United States
(12) Patent Application Publication
(10) Pub. No.: US 2026/0096537 A1
(43) Pub. Date: Apr. 9, 2026

(54) Pet Slow Feeder with Threaded Food Dispensing Mechanism

(71) Applicant: Shorooq Alzookery, Irvine, CA (US)

(72) Inventor: Shorooq Alzookery, Irvine, CA (US)

(21) Appl. No.: 19/348,773

(22) Filed: Oct. 2, 2025

Related U.S. Application Data
(60) Provisional application No. 63/702,661, filed on Oct. 3, 2024.

(51) Int. Cl. A01K 5/01; A01K 5/02

(52) U.S. Cl. CPC A01K 5/0135; A01K 5/0225

(57) ABSTRACT

The invention provides a pet slow feeder designed to regulate the dispensing of dry food in controlled portions. The feeder includes a rotatable food container mounted above a feeding plate, coupled to a threaded or guide mechanism enclosed within a housing. Rotation of the container by a human operator causes food to travel along a controlled path and descend into the plate, with resistance in the mechanism preventing pets from self-dispensing. The feeder promotes healthier eating by slowing consumption and preventing overfeeding, while maintaining hygienic and user-friendly operation.

### CROSS-REFERENCE TO RELATED APPLICATION

This application claims the benefit of the following U.S. Provisional Application No. 63/702,661, filed Oct. 3, 2024, the entire contents of which are incorporated herein by reference.

### BACKGROUND OF THE DISCLOSURE

### Field of the Disclosure

The present invention relates to pet feeding apparatus, specifically a slow feeder that allows controlled dispensing of food from a rotatable container onto a feeding plate.

### Brief Description of Related Technology

Some pets, especially cats, consume food at an excessive rate, which can cause digestive problems, obesity, or discomfort. Many slow feeders in the market fail to dispense the right amount of pet dry food based on the pet's individual needs, which can result in inconsistent feeding and overconsumption. Some feeders offer a complex design with fixed feeding difficulty that can lead to frustration and even disinterest in eating.

There is a need for a feeder that allows controlled, measured food dispensing, with adjustable feeding rate, while ensuring the pet is engaged in the feeding process and staying healthy.

The ornamental aspects of the feeder are the subject of U.S. Design Pat. No. D1,084,538 S. The present application is directed to the functional features of the feeder, including the rotatable container and controlled dispensing mechanism.

### SUMMARY OF THE DISCLOSURE

The present invention provides a pet slow feeder designed to regulate the dispensing of dry pet food in a controlled and safe manner.

The feeder comprises a rotatable food container mounted above a feeding plate and coupled to a threaded mechanism enclosed within a housing.

The threaded mechanism is configured with sufficient resistance such that only a human hand grip can assert force to rotate the container and control the amount of dispensed food. The threaded mechanism is configured to provide sufficient resistance such that rotation of the container, and thus regulation of the dispensed food quantity, can only be achieved through manual operation by a human operator.

Rotation of the container causes food to travel along a controlled path and descend into the feeding plate, setting the feeding difficulty, which is governed by the extent of the rotation.

The feeding plate can be shallow, concave, and dishwasher-safe to ensure safe and hygienic operation.

Alternative embodiments of the mechanism, including different thread or rotational guide designs, providing adjustable control over the rate of food dispensing.

This invention addresses uncontrolled feeding in pets, particularly cats, by providing slow, controlled, human-mediated dispensing, ensuring pets receive measured portions while preventing overconsumption.

### BRIEF DESCRIPTION OF THE DRAWINGS

The accompanying drawings illustrate example embodiments and are not intended to limit the scope of the invention.

FIGS. 1A-1C show perspective views of the feeder.

FIG. 2A is a top plan view of the feeder, and FIG. 2B is a bottom plan view of the feeder.

FIGS. 3A and 3B show side and cross-sectional views of the feeder, respectively.

FIGS. 4A and 4B illustrate, respectively, an exploded and a detailed view of the feeder.

FIGS. 5A and 5B show cross-sectional views illustrating adjustable food dispensing by rotation.

FIGS. 6A and 6B show sequential views illustrating operation of the feeder.

FIG. 7 is an exploded view of the feeder.

### DETAILED DESCRIPTION

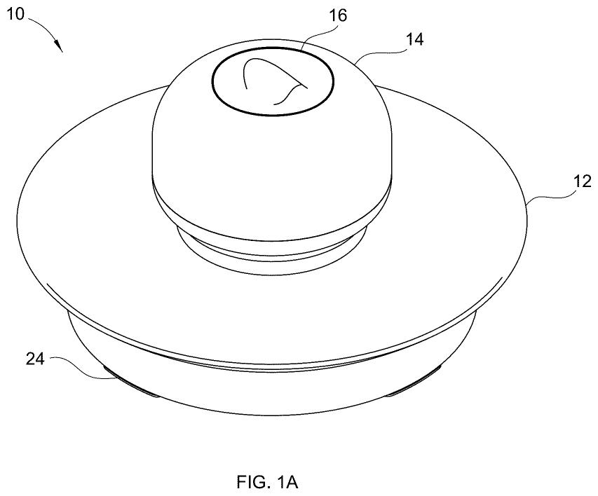

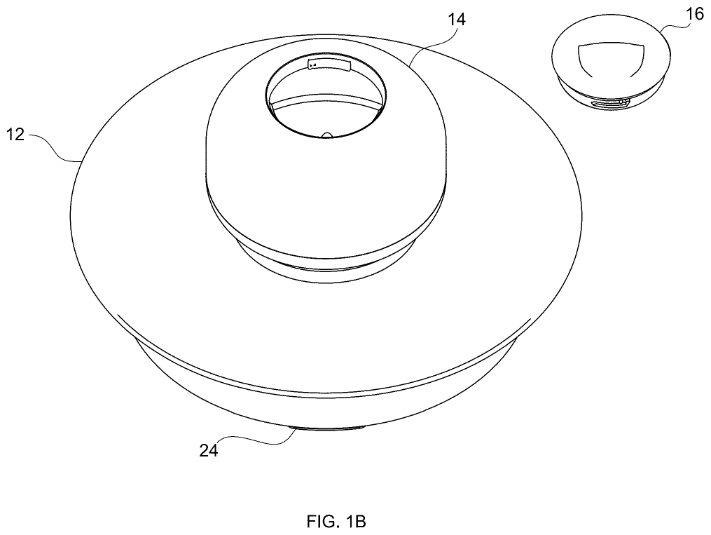

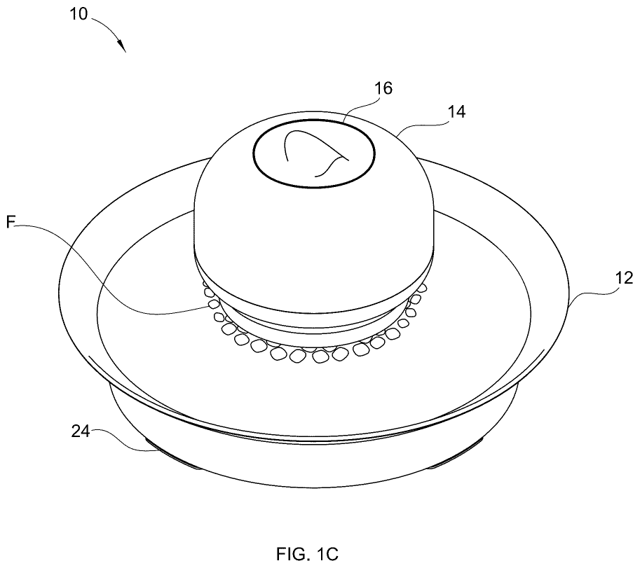

FIG. 1A shows the feeder fully assembled with lid 16 closed, and FIG. 1B shows the feeder with lid 16 removed, exposing the food compartment 14. FIG. 1C shows the feeder in use, with food F dispensed from the food compartment 14 into the feeding plate 12. Non-slip rubber pads 24 are visible on the bottom of the plate.

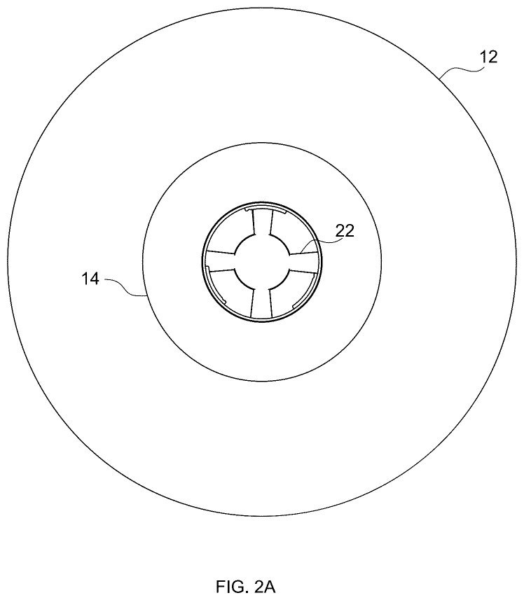

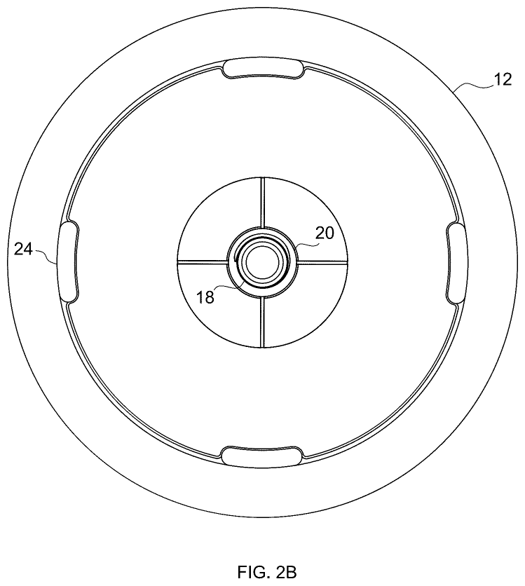

FIG. 2A is a top plan view showing the feeding plate 12 and food path opening 22, with the lid removed. FIG. 2B is a bottom plan view showing placement of non-slip rubber pads 24 on the underside of the feeding plate 12.

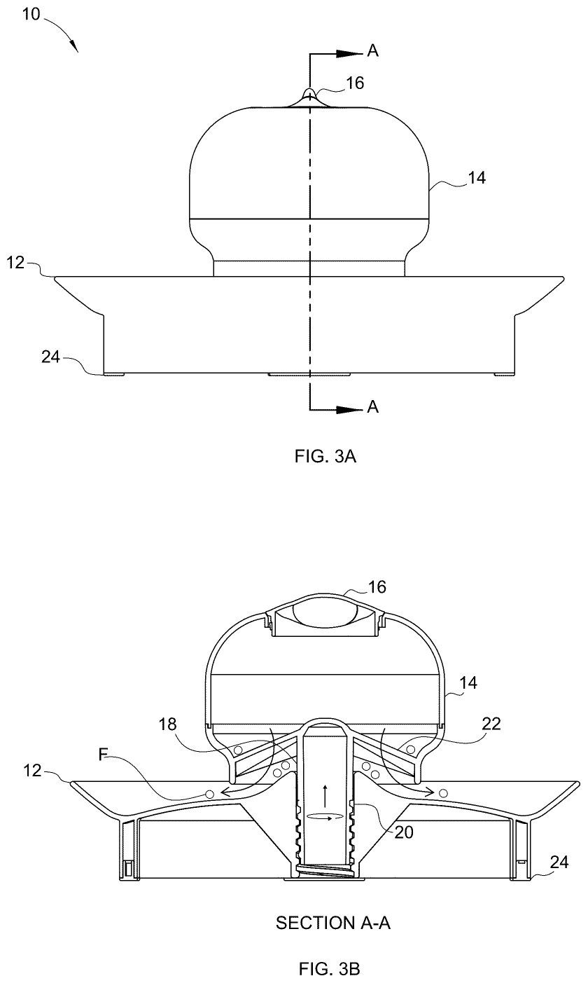

FIG. 3A is a side elevation view of the fully assembled feeder. FIG. 3B is a cross-sectional view along line A-A showing the food compartment 14 with male thread 18 engaged with the female thread 20 of the feeding plate 12, and the food path opening 22, allowing gravity-fed dispensing. Arrows indicate the direction of food movement by gravity.

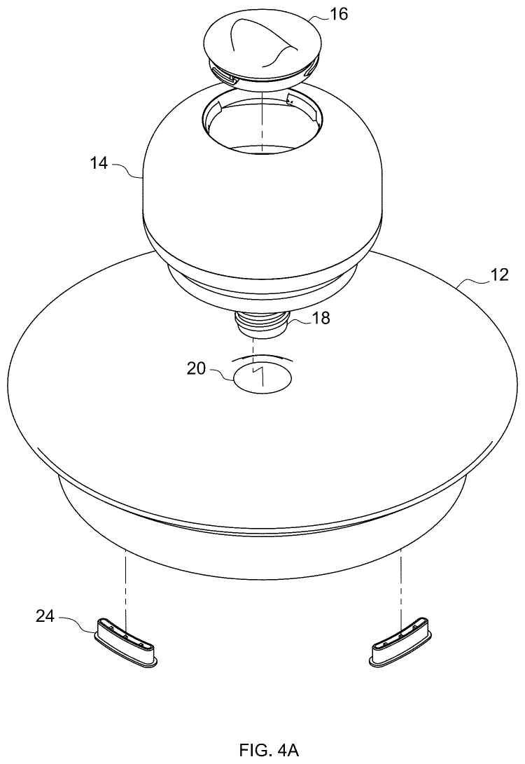

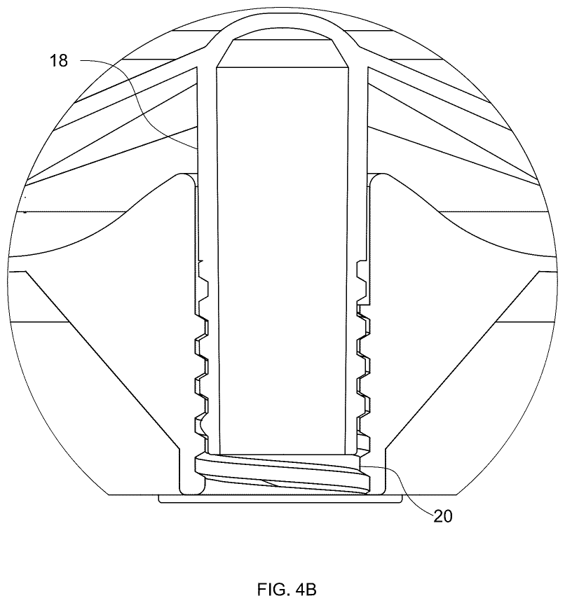

FIG. 4A is an exploded isometric view showing the lid 16, food compartment 14, feeding plate 12, and non-slip rubber pads 24. FIG. 4B is an enlarged cross-sectional detail view of the threaded interface between the food compartment 14 and feeding plate 12, taken from the threaded mechanism region in FIG. 3B, illustrating the resistance/detent mechanism requiring human-applied torque to dispense food.

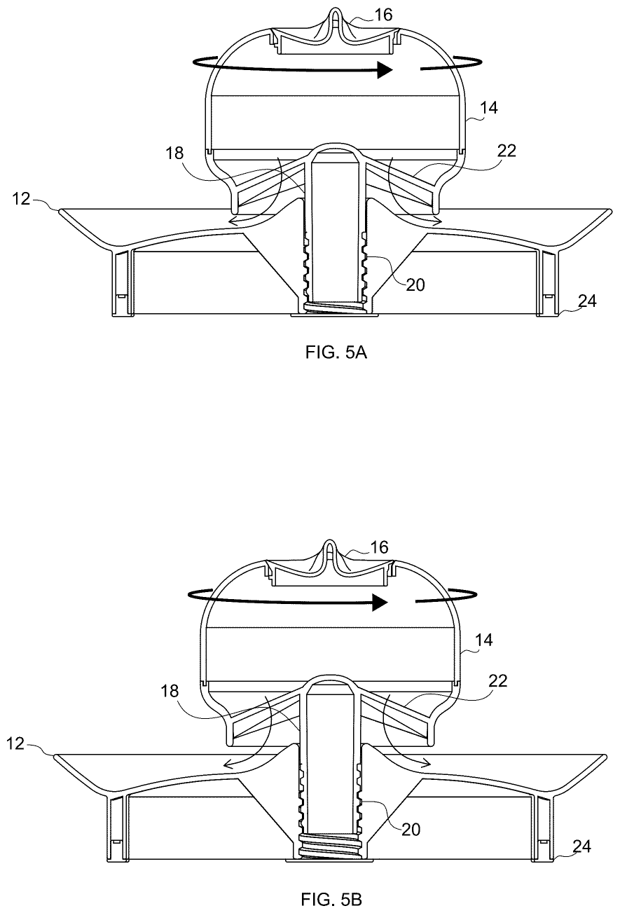

FIG. 5A shows the food compartment 14 rotated partially to create a small opening for limited food flow through the food path 22. FIG. 5B shows the food compartment 14 rotated further to create a larger opening, allowing increased food flow. Arrows indicate the direction of food movement by gravity. The opening size reflects the precise height adjustment of the food compartment relative to the food plate, allowing the control of dispensed food portions.

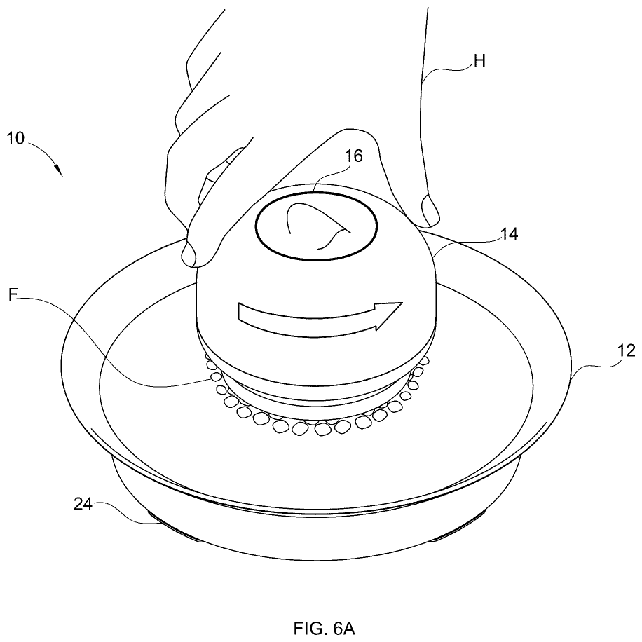

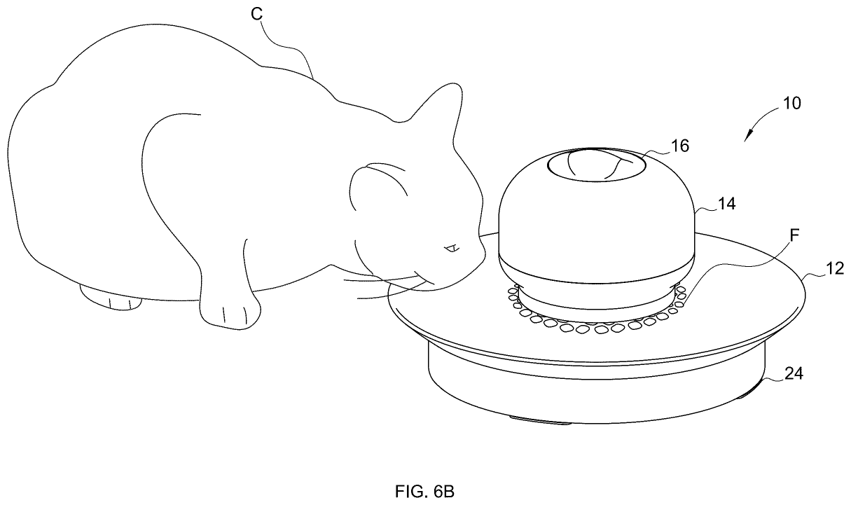

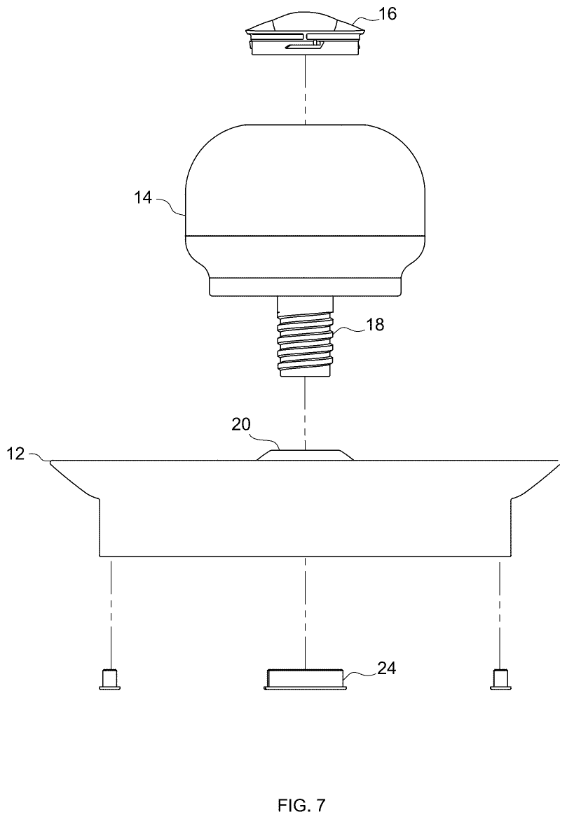

FIG. 6A shows a simplified human hand H rotating the food compartment 14 in an anticlockwise direction curved arrow, with the lid 16 closed. FIG. 6B shows a cat C interacting with the feeder, consuming food F dispensed into the feeding plate 12.

FIG. 7 is an exploded view of the feeder showing the food container 14, mechanism housing 18/20, feeding plate 12, lid 16, and rubber pads 24.

The feeder includes a rotatable food container 14 as shown in FIGS. 1A-1C, 2A, and 6A-B, configured to store dry pet food such as kibble, treats, or air-dried food. The food container 14 is mounted above the feeding plate 12 and engages the threaded mechanism housing.

The threaded mechanism 18/20 is located within the housing, as shown in FIGS. 3B, 4B, and 5A-B. The mechanism engages the container 14 and feeding plate 12 to provide controlled rotation. The mechanism provides sufficient resistance such that a human operator can rotate the container 14 by hand, as illustrated in FIG. 6A. The threading mechanism, as shown in FIG. 4B, may be implemented using a variety of alternative configurations, without limiting the scope of the invention.

The feeding plate 12 is positioned beneath the container 14 to catch dispensed food, as shown in FIGS. 1C, 3B, and 6A-B. The plate can be shallow or slightly concave to prevent spillage of the dispensed dry food. Non-slip rubber pads 24 are attached to the underside of the plate to stabilize the feeder during use.

To dispense food, a human hand rotates the container 14 as shown in FIGS. 6A, overcoming the resistance of the mechanism 18/20. Food moves along the controlled path 22 and descends into the feeding plate 12, as shown in FIGS. 2A, 3B and 5A-B. The design ensures controlled portioning while preventing pets from rotating the container.

The mechanism can vary in design, size, or resistance level while maintaining human-only operation. The feeding plate 12 and container 14 may be detachable for cleaning purposes. Although cats are the primary example, the feeder can be applied to any pet consuming dry food.

What is claimed is:

1. A pet slow feeder comprising:
a rotatable food container having an external thread;
a feeding plate positioned below the container and having a corresponding internal thread configured to engage the external thread.

2. The pet slow feeder of claim 1, wherein the external thread and the internal thread are configured to allow vertical adjustment of the container relative to the plate, enabling controlled dispensing rates and flexible feeding.

3. The pet slow feeder of claim 1, wherein the feeding plate is shallow or concave to prevent spillage of food dispensed from the container.

4. The pet slow feeder of claim 1, wherein the feeding plate comprises a central surface protrusion configured to direct dispensed food outwardly across the plate, ensuring continuous supply of food until the container is empty.

5. The pet slow feeder of claim 1, wherein the threaded engagement comprises one of: a helical thread, a screw-type mechanism, or an alternative rotationally-guided structure configured to regulate dispensing and maintain human-only operation.

6. A method of dispensing pet food, comprising:
storing food in a rotatable container having an external thread;
manually rotating the container by a human user;
engaging the external thread with an internal thread of a feeding plate, such that rotation of the container causes relative vertical movement between the container and plate;
moving food downward from the container onto the plate by said relative movement;
wherein the threaded engagement is configured to provide sufficient resistance to prevent pets from rotating the container.

7. The pet slow feeder of claim 1, wherein the feeder is suitable for dispensing pet dry food or treats to cats, small dogs, or other small animals.

8. A pet slow feeder comprising:
a rotatable food container;
a feeding plate positioned below the container;
a rotational engagement mechanism connecting the container to the feeding plate;
wherein the rotational engagement mechanism is configured to move food from the container onto the feeding plate upon rotation by a human operator, and provides sufficient resistance to prevent rotation by a pet, thereby enabling controlled, human-only dispensing of food.
